(19) United States
(12) Patent Application Publication
(10) Pub. No.: US 2013/0290830 A1
(43) Pub. Date: Oct. 31, 2013

(54) SYSTEM AND METHOD FOR MANAGING A VIEWSTATE OF A WEB APPLICATION

(71) Applicant: SALESFORCE.COM, INC., San Francisco, CA (US)

(72) Inventor: Igor Shmulevich, San Ramon, CA (US)

(73) Assignee: SALESFORCE.COM, INC., San Francisco, CA (US)

(21) Appl. No.: 13/837,285

(22) Filed: Mar. 15, 2013

Related U.S. Application Data
(60) Provisional application No. 61/640,444, filed on Apr. 30, 2012.

(51) Int. Cl. G06F 17/22

(52) U.S. Cl. CPC G06F 17/2247
USPC 715/234

(57) ABSTRACT

In one embodiment, a computer-implemented method executable by a server system to manage a viewstate of a web page of a web application having one or more forms is provided. The method includes maintaining a single viewstate on the web page of the web application at a location outside of the one or more forms; and managing a submission of information of the one or more forms of the web page based on the single viewstate.

### CROSS-REFERENCE TO RELATED APPLICATION

This application claims the benefit of U.S. provisional patent application Ser. No. 61/640,444, filed Apr. 30, 2012, which is hereby incorporated by reference in its entirety.

### TECHNICAL FIELD

Embodiments of the subject matter described herein relate generally to methods and systems for managing a viewstate of a web application. More particularly, embodiments of the subject matter relate to methods and systems of managing a viewstate in an on demand or multi-tenant environment using a single copy of viewstate information.

### BACKGROUND

Modern software development is evolving away from the client-server model toward network-based processing systems that provide access to data and services via the Internet or other networks. In contrast to traditional systems that host networked applications on dedicated server hardware, a “cloud” or “on demand” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

A plethora of already built and/or new applications may be available from the cloud to any customer. The applications may be web-based applications that require user interaction. When a user interacts with a web application, the user's viewstate (i.e., the state of the web page that may include a user's unsaved updates, history, and so forth) are preserved as the user posts data to forms of the same, or different, web pages. There may be multiple instances of viewstates for any single web page.

Typically a viewstate is preserved by serializing the data into a string of characters and downloading the serialized data to the user's browser as a hidden input field. When the user posts data back using HTML form or some other form, the viewstate is also sent back as one of the form parameters and then interpreted by the server.

The traditional approach has been to include a copy of the viewstate into every form of the web page even though material of the copies may be identical. While the viewstate size by itself is relatively small compared to a typical size of a web page, when there is more than one HTML form on a page, the size of the stored viewstate increases with each form. In a complex page, the viewstate may reach 100 kb (or more) even when compressed. One implementation size limit is 135 kb. It is not uncommon to have 5-10 forms on the page resulting in an increase of 0.5-1.0 Mb in page size to simply accommodate the viewstate. This translates into higher consumption of the server resources, higher bandwidth utilization, and additional overhead in browser processing.

Accordingly, it is desirable to provide improved methods and products for managing the viewstate of a web application. In addition, it is desirable to provide methods and products for managing the viewstate in an on demand environment. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a functional block diagram illustrating an on demand, multi-tenant system including a viewstate system in accordance with various embodiments.

FIG. 2 is a dataflow diagram illustrating a viewstate manager of the viewstate system in accordance with various embodiments.

FIG. 3 is an illustration of a web page generated by the viewstate manager in accordance with various embodiments.

FIGS. 4 and 5 are flowcharts illustrating viewstate manager methods in accordance with various embodiments.

### DETAILED DESCRIPTION

The following detailed description is merely exemplary in nature and is not intended to limit the disclosure the application and uses of the disclosure. Furthermore, there is no intention to be bound by any expressed or implied theory presented in the preceding technical field, background, brief summary or the following detailed description. It should be understood that throughout the drawings, corresponding reference numerals indicate like or corresponding parts and features.

The exemplary embodiments presented herein relate to a viewstate system and related techniques, methodologies, procedures, and technology for managing a viewstate of a virtual web application. The described subject matter can be implemented in the context of any computer-implemented system, such as a software-based system, a database system, an on demand environment, or the like. Moreover, the described subject matter can be implemented in connection with two or more separate and distinct computer-implemented systems that cooperate and communicate with one another.

In accordance with exemplary embodiments described below, an on demand computer based system is provided, such as a multi-tenant system 100, that is used to provide web applications and other applications to a plurality of different tenants, a plurality of different end users, and/or a plurality of different tenant applications. The viewstate system manages the viewstate of a web application as the tenants, end users, and/or tenant applications are interacting with the web application.

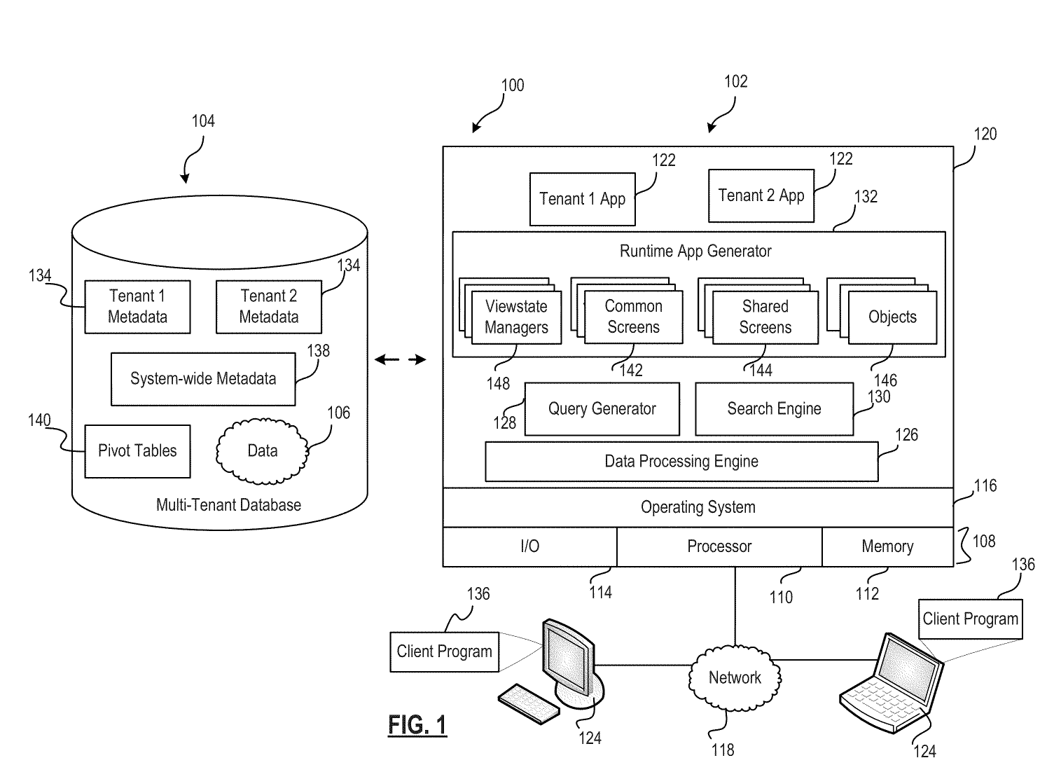

Turning now to FIG. 1, the exemplary multi-tenant system 100 is shown to include a server 102 that is associated with a multi-tenant database 104. In accordance with various non-limiting examples, the system 100 may be implemented in the form of a multi-tenant customer relationship management system that can support any number of authenticated users of multiple tenants. A “tenant” or an “organization” generally refers to a group of users that shares access to common data 106 within the database 104. Tenants may represent customers, customer departments, business or legal organizations, and/or any other entities that maintain data for particular sets of users within the system 100. Although multiple tenants may share access to the server 102 and the database 104, the particular data and services provided from the server 102 to each tenant can be securely isolated from those provided to other tenants. The multi-tenant architecture therefore allows different sets of users to share functionality while managing the sharing of any or none of the data 106.

The server 102, as shown, generally includes any sort of conventional processing hardware 108, such as a processor 110, memory 112, input/output features 114 and the like, that are managed and accessed by a suitable operating system 116. The processor 110 may be implemented using one or more of microprocessors, microcontrollers, processing cores and/or other computing resources spread across any number of distributed or integrated systems, including any number of “cloud-based” or other virtual systems. The memory 112 represents any non-transitory short or long term storage capable of storing programming instructions for execution on the processor 110, including any sort of random access memory (RAM), read only memory (ROM), flash memory, magnetic or optical mass storage, and/or the like. The input/output features 114 represent conventional interfaces to networks (e.g., to a network 118, or any other local area, wide area or other network), mass storage, display devices, data entry devices and/or the like. As can be appreciated, the server 102 may be implemented using a cluster of actual and/or virtual servers operating in conjunction with each other, typically in association with conventional network communications, cluster management, load balancing and other features as appropriate

The server 102 typically includes or cooperates with some type of computer-readable media, where a tangible computer-readable medium has computer-executable instructions stored thereon. The computer-executable instructions, when read and executed by the server 102, cause the server 102 to perform certain tasks, operations, functions, and processes described in more detail herein. In this regard, the memory 112 may represent one suitable implementation of such computer-readable media. Alternatively or additionally, the server 102 could receive and cooperate with computer-readable media (not separately shown) that is realized as a portable or mobile component or platform, e.g., a portable hard drive, a USB flash drive, an optical disc, or the like.

The server 102, as shown, further includes an application platform 120 that may be any sort of software application or other data processing engine that generates virtual applications 122 that provide data and/or services to user devices 124. The virtual applications 122 are typically generated at run-time in response to queries received from the user devices 124. The user devices 124 are typically operated by various tenants that subscribe to the system 100. In various embodiments, the virtual applications 122 are web-based applications that include one or more web pages that may be accessed by the user devices 124.

In the illustrated embodiment, the application platform 120 includes a bulk data processing engine 126, a query generator 128, a search engine 130 that provides text indexing and other search functionality, and a runtime application generator 132. Each of these features may be implemented as a separate process or other module, and many equivalent embodiments could include different and/or additional features, components or other modules as desired.

The data processing engine 126 performs bulk processing operations on the data 106 such as uploads or downloads, updates, online transaction processing, and/or the like that are requested by the query generator 128, the search engine 130, the virtual applications 122, etc. In various embodiments, less urgent bulk processing of the data 106 can be scheduled to occur as processing resources become available, thereby giving priority to more urgent data processing by the query generator 128, the search engine 130, the virtual applications 122, etc.

The runtime application generator 132 dynamically builds and executes the virtual applications 122 in response to specific requests received from the user devices 124. The virtual applications 122 created by or for the tenants are typically constructed in accordance with the tenant-specific metadata 134, which describes particular tables, reports, interfaces and/or other features of the particular application. In various embodiments, each virtual application 122 generates dynamic web content that can be served to a browser or other client program 136 associated with its user device 124, as appropriate. As used herein, such web content represents one type of resource, data, or information that may be protected or secured using various user authentication procedures.

The runtime application generator 132 interacts with the query generator 128 to efficiently obtain multi-tenant data 106 from the database 104 as needed. In various embodiments, the query generator 128 considers the identity of the user requesting a particular function, and then builds queries to be executed on the database 104 using system-wide metadata 138, tenant specific metadata 134, pivot tables 140, and/or any other available resources. The query generator 128 maintains security of the common database 104 by ensuring that queries are consistent with access privileges granted to a user that initiated the request. The query generator 128 suggests alternate queries based on the initial request while maintaining the security of the common database 104.

The database 104 is any sort of repository or other data storage system capable of storing and managing the data 106 associated with any number of tenants. The database 104 may be implemented using any type of conventional database server hardware. In various embodiments, the database 104 shares processing hardware 108 with the server 102. In other embodiments, the database 104 is implemented using separate physical and/or virtual database server hardware that communicates with the server 102 to perform the various functions described herein.

The data 106 may be organized and formatted in any manner to support the application platform 120. In various embodiments, the data 106 is suitably organized into a relatively small number of large data tables to maintain a semi-amorphous “heap”-type format. The data 106 can then be organized as needed for a particular virtual application 122. In various embodiments, conventional data relationships are established using any number of pivot tables 140 that establish indexing, uniqueness, relationships between entities, and/or other aspects of conventional database organization as desired.

Further data manipulation and report formatting is generally performed at run-time using a variety of metadata constructs. The system-wide metadata 138, for example, can be used to describe any number of forms, reports, workflows, user access privileges, business logic and other constructs that are common to multiple tenants. Tenant-specific formatting, functions and other constructs may be maintained as tenant-specific metadata 134 for each tenant, as desired. Rather than forcing the data 106 into an inflexible global structure that is common to all tenants and applications, the database 106 is organized to be relatively amorphous, with the pivot tables 140 and the metadata 134 providing additional structure on an as-needed basis. To that end, the application platform 120 suitably uses the pivot tables 140 and/or the metadata 134 to generate “virtual” components of the virtual applications 122 to logically obtain, process, and present the relatively amorphous data 106 from the database 104.

In operation, developers use the application platform 120 to create data-driven virtual applications 122 for the tenants that they support. Such virtual applications 122 may make use of interface features such as tenant-specific screens 142, universal screens 144 or the like. Any number of tenant-specific and/or universal objects 146 may also be available for integration into tenant-developed virtual applications 122. The data 106 associated with each virtual application 122 is provided to the database 104, as appropriate, and stored until it is requested or is otherwise needed, along with the metadata 134 that describes the particular features (e.g., reports, tables, functions, etc.) of that particular tenant-specific virtual application 122.

The data and services provided by the server 102 can be retrieved using any sort of personal computer, mobile telephone, portable device, tablet computer, or other network-enabled user device 124 that communicates via the network 118. Typically, the user operates a conventional browser or other client program 136 to contact the server 102 via the network 118 using, for example, the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 122, the runtime application generator 132 suitably creates the application at run time based upon the metadata 134, as appropriate. The query generator 128 suitably obtains the requested data 106 from the database 104 as needed to populate the tables, reports or other features of the particular virtual application 122. As noted above, the virtual application 122 may contain Java, ActiveX, or other content that can be presented using conventional client software running on the user device 124; other embodiments may simply provide dynamic web or other content that can be presented and viewed by the user, as desired.

In various embodiments, the runtime application generator 132 includes one or more viewstate managers 148 that manage a viewstate of the virtual applications 122 as users interact with the virtual applications 122 via the user devices 124. In particular, a viewstate manger 148 manages the viewstate of the virtual application 122 by managing only a single copy of a viewstate of a particular web page of the virtual application 122 (referred to as a single viewstate). For example, the viewstate manager 148 generates a custom script for each web page of the virtual application 122 as the web page is being rendered, and the custom script manages the single copy by linking the single copy to any of the forms of the web page right before the form is submitted to the server 102 by the user device 124. Since all of the copies of the viewstate would be identical, the viewstate needs only be rendered once per web page and then programmatically added to a post request before the form data is submitted to the server 102 by the user device 124.

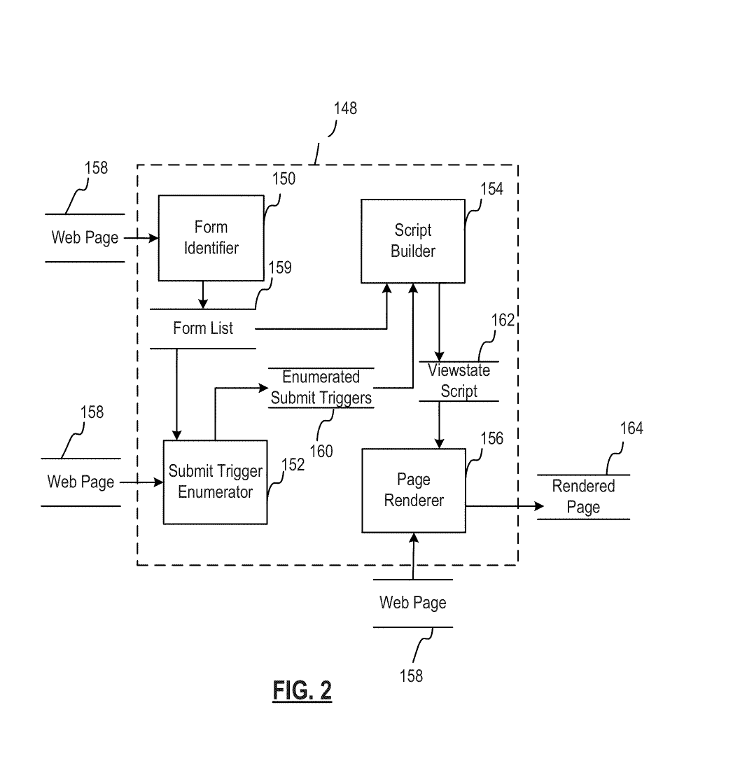

Turning now to FIG. 2 a block diagram illustrates an exemplary viewstate manager 148 suitable for use in a computer-implemented server system such as the system 100 shown in FIG. 1. This generalized exemplary embodiment of the viewstate manager 148 includes a form identifier 150, a submit trigger enumerator 152, a script builder 154, and a page renderer 156.

The form identifier 150 processes a page 158 of the virtual application 122 (FIG. 1) to identify any forms on the page 158. A single page 158 may have any number of forms. In various embodiments, the form identifier 150 identifies all of the forms on the page 158 and collects ID's of all the forms on the page 158. For example, some forms are added explicitly through a web component (e.g., <apex:form>, or other type of component) and some forms may be added implicitly through another web component (e.g., <apex:tabPanel>or by enabling an inline edit feature in components like <apex:outputField>, <apex:outputField>, <apex:detail>, or other type of component). The form identifier 150 identifies these explicit and implicit web components and compiles a form list 159 including all of the ID's of the web components.

The submit trigger enumerator 152 processes the page 158 of the virtual application 122 based on the form list 159 and identifies any web components that would trigger a submit of information entered in the forms, referred to as submit triggers. The submit triggers can include, but are not limited to, a user-initiated submit that is triggered by a user action (e.g., via a user clicking a “submit” or “OK” button of the web page), an event-initiated submit that is triggered by an event that occurs as a result of a user action (e.g., via a script such as a JavaScript or other function that is called as a result of a user interaction with the web page), and a request-initiated submit that is triggered by a request for information (e.g., via a polling function, such as, A4J.AJAX.Poll( )function, or other function that periodically requests the information). The submit trigger enumerator 152 enumerates the submit triggers (referred to as the enumerated submit triggers 160) for each identified form of the form list 159.

The script builder 154 receives the form list 159 and the enumerated submit triggers 160 for the current page 158. Based on the form list 159 and the enumerated submit triggers 160, the script builder 154 builds a viewstate script 162 for the page 158. For example, the script builder 154 builds a sub-script for each submit trigger of each form and builds the viewstate script 162 as a compilation of the sub-scripts. In other words, if the page 158 includes three forms, with two submit triggers for this first form, one submit trigger for the second form, and one submit trigger for the third form, then the script builder 154 builds five sub-scripts, one for each submit trigger and builds the viewstate script 162 from the five sub-scripts. Submit triggers may include, but are not limited to, a click on form Submit button, a call to onclick( ) JavaScript handler for an HTML element, and a direct JavaScript invocation of form.submit( ) function based on other user or programmatic events (e.g., browser page lifecycle events like window.onload or JavaScript timer events).

In general, each sub-script determines that the submit trigger has been initiated and moves the viewstate from a location outside of the particular form associated with the submit trigger to a location inside of the form before the form information is submitted or “posted” to the server 102 (FIG. 1). The sub-script may move the viewstate by way of a new submit function that physically moves the viewstate into the form or by way of a modified library that references the outside location of the viewstate and does not physically move the viewstate. As can be appreciated, the sub-script may operate similarly for posting from data encoded in various ways such as application/x-www-form-urlencoded or multipart/form-data in a single form or multiple forms.

For example, in the case when the submit trigger is a user-initiated submit trigger where the user clicks on a submit button triggering a submit event, the sub-script overwrites a form onSubmit( ) function with a new submit function vfOnSubmit( ). This new function moves the single viewstate into the form and then calls the original onSubmit( ). When the submit function is complete, the new function moves the single viewstate back to the location on the page outside of the form. In some cases, when performing submit causes the entire page to reload, moving single viewstate back is not needed, as everything will be re-initialized. In other cases, the onSubmit( ) function is used to validate form data. In this case, the new submit function vfOnSubmit( ) moves the single viewstate into the form and performs the validation of the form data. If the form data is not valid, the new function moves the single viewstate back to the location on the page outside of the form. In other words, the supporting single viewstate sub-script ensures that viewstate is always present in (or linked to) a form before that form is submitted, with or without validation and regardless of the trigger that caused the submission. The single viewstate sub-script also handles a full page reload or partial page updates resulted from the submission. When the page is not fully reloaded after the submission, single viewstate is re-initialized to be available for the next submission of the same or another form on the page.

In another example, in the case that the submit trigger is an event-initiated submit trigger where some event calls or triggers a submit event, the sub-script overwrites a form submit( ) function with a new submit function vfSubmit( ). The new function moves the single viewstate into the form and then calls the original submit( ) function. When the submit is complete, the new function moves the single viewstate back to the location on the page outside of the form.

In yet another example, in the case that the submit trigger initiates a different way to submit form data (i.e., an Ajax request, or JSON request) the sub-script complements the existing library functionality to either perform functions to move the single viewstate inside the form as discussed above or to add the viewstate from the location outside of the form to a list of request parameters that are used to create the form data to be posted (e.g., the RichFaces library may be updated to add the new viewstate to the list of Ajax request parameters).

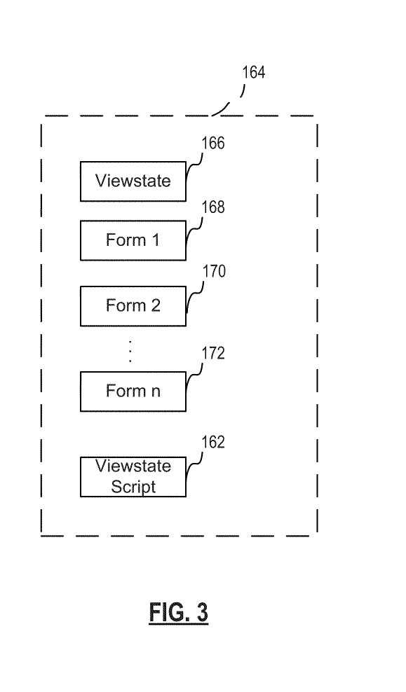

The page renderer 156 receives the page 158 and the viewstate script 162. The page renderer 156 inserts the viewstate and the viewstate script 162 in the web page 158 and renders page 164. As discussed above, the page renderer 156 inserts the viewstate in the page 158 at a location that is outside of any form on the page 158. For example, as shown in FIG. 3, the page includes a plurality of forms 168-172, the viewstate 166, and the viewstate script 162.

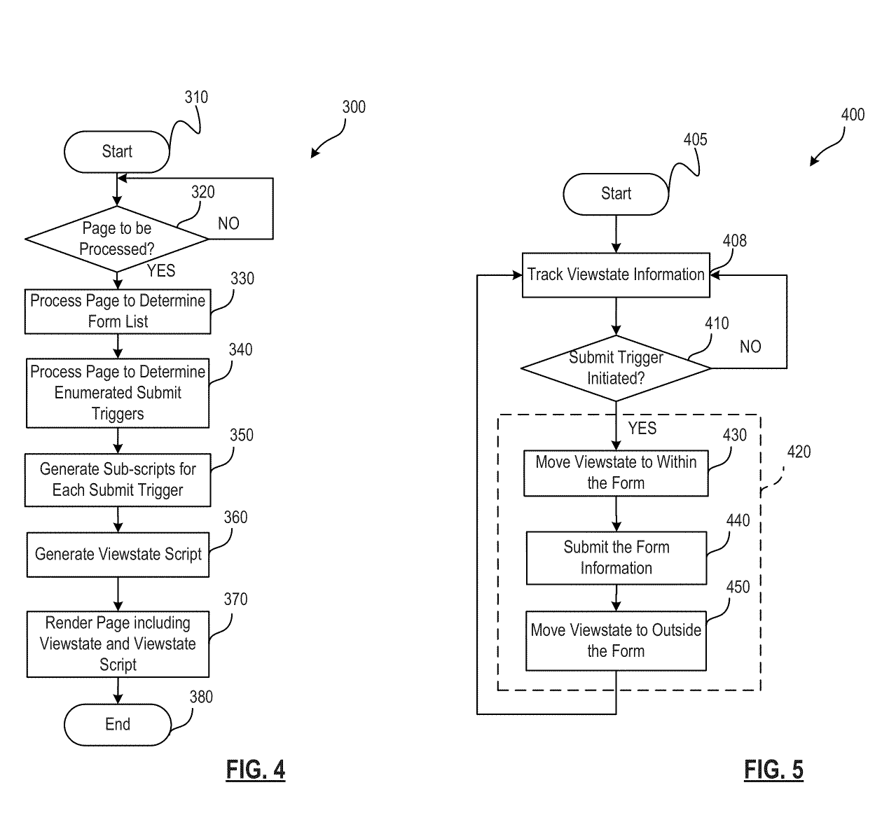

Turning now to FIGS. 4 and 5, flowcharts illustrate exemplary methods 300, 400 for managing a single viewstate. The various tasks performed in connection with the methods 300, 400 may be performed by software, hardware, firmware, or any combination thereof. In other words, the methods 300, 400 may represent computer-implemented methods to manage a single viewstate. In particular, the methods, 400 300 are executable by a suitably configured server system or a functional module of a server system, such as the viewstate system described above. For illustrative purposes, the following description of the methods 300, 400 may refer to elements mentioned above in connection with FIGS. 1-3. In practice, portions of the methods 300, 400 may be performed by different elements of the described system, e.g., the viewstate manager 148, the client program 136, or the like. As can be appreciated, the methods 300, 400 may include any number of additional or alternative steps, the steps shown in FIGS. 4 and 5 need not be performed in the illustrated order, and the methods 300, 400 may be incorporated into a more comprehensive procedure or process having additional functionality not described in detail herein. Moreover, one or more of the steps shown in FIGS. 4 and 5 could be omitted from embodiments of the methods 300, 400 as long as the intended overall functionality remains intact.

The methods 300, 400 assume that the server 102 has already been provided with the modules and functionality described above.

With reference to FIGS. 4 and 5, methods 300 and 400 of managing a single viewstate are shown. In one example, the method 300 is performed by the server 102. The method may begin at 310. A request to process a web page is received by the server 102 at 320. Once a request is received at 320, the page 158 is processed at 330 to determine the form list 159. The page 158 is further processed at 340 to determine the enumerated submit triggers 160 for each form of the form list 159. Sub-scripts are built from each of the submit triggers of each form of the form list 159 at 350. The viewstate script 162 is built from the sub-scripts at 360. The viewstate and the viewstate script is inserted into the page as it is being rendered at 370. Thereafter, the method may end at 380.

In another example, the method 400 is performed by the user device 124. The method may begin at 405. The viewstate information is tracked in the viewstate 166 at 408. It is determined whether a submit trigger is initiated at 410. If a submit trigger is not initiated at 410, the method continues with tracking the viewstate information at 408. If, however, a submit trigger is initiated at 410, the particular sub-script of the viewstate script 174 that is associated with the submit trigger for the particular form is executed at 420. In particular, the sub-script moves the viewstate into the form at 430 and then submits the form information at 440. Once the form information is submitted, the sub-script moves the viewstate back to its original location at 450. Thereafter, the method continues with tracking the viewstate information at 408.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method executable by a server system to manage a viewstate of a web page of a web application having one or more forms, the method comprising:
maintaining a single viewstate on the web page of the web application at a location outside of the at least one form; and
managing a submission of information of the one or more forms of the web page based on the single viewstate.

2. The computer-implemented method of claim 1 further comprising:
building a script that manages the submission of information of the one or more forms of the web page based on the single viewstate; and
inserting the script into the page.

3. The computer-implemented method of claim 2 further comprising identifying at least one submit trigger associated with the one or more forms of the web page, and wherein the building the script is based on the at least one submit trigger.

4. The computer-implemented method of claim 3 wherein the identifying comprises identifying a user-initiated submit trigger that is triggered based on a user action.

5. The computer-implemented method of claim 3 wherein the identifying comprises identifying an event-initiated submit trigger that is triggered based on an event.

6. The computer-implemented method of claim 3 wherein the identifying comprises identifying a request-initiated submit trigger that is triggered based on a request.

7. The computer-implemented method of claim 2 wherein the web page has a plurality of forms, and wherein the method further comprises identifying the plurality of forms of the web page, and wherein the building the script is based on the plurality of forms.

8. The computer-implemented method of claim 2 wherein the web page has a plurality of forms, and wherein the method further comprises:
identifying the plurality of forms of the web page;
identifying at least one submit trigger associated with each of the plurality of forms of the web page, and
wherein the building the script is based on the plurality of forms and the associated at least one submit trigger.

9. The computer-implemented method of claim 1 wherein the script moves the single viewstate to a location within the one or more forms, submits the information in the one or more forms including the viewstate, and moves the viewstate back to the location outside of the form.

10. The computer-implemented method of claim 1 wherein the script associates the viewstate with the one or more forms using a library, and submits the information in the one or more forms using the library.

11. A multi-tenant server system for managing a viewstate of a web page of a web application having one or more forms, comprising:
a database that stores multi-tenant data that includes the web page of the web application having the one or more forms; and
a server system that maintains a single viewstate on the web page of the web application at a location outside of the one or more forms, and that manages a submission of information of the one or more forms of the web page based on the single viewstate.

12. The multi-tenant server system of claim 11 wherein the server system builds a script that manages the submission of information of the one or more forms of the web page based on the single viewstate and inserts the script into the page.

13. The multi-tenant server system of claim 12 wherein the server system identifies at least one submit trigger associated with the one or more forms of the web page, and wherein the server system builds the script based on the at least one submit trigger.

14. The multi-tenant server system of claim 13 wherein the server system identifies a user-initiated submit trigger that is triggered based on a user action.

15. The multi-tenant server system of claim 13 wherein the server system identifies an event-initiated submit trigger that is triggered based on an event.

16. The multi-tenant server system of claim 13 wherein the server system identifies a request-initiated submit trigger that is triggered based on a request.

17. The multi-tenant server system of claim 12 wherein the web page has a plurality of forms and wherein the server system identifies the plurality of forms of the web page and builds the script based on the plurality of forms.

18. The multi-tenant server system of claim 12 wherein the web page has a plurality of forms and wherein the server system identifies the plurality of forms of the web page, identifies at least one submit trigger associated with each of the plurality of forms of the page, and builds the script based on the plurality of forms and the associated at least one submit trigger.

19. The multi-tenant server system of claim 11 wherein the script moves the single viewstate to a location within the one or more forms, submits the information in the one or more forms including the viewstate, and moves the viewstate back to the location outside of the form.

20. The multi-tenant server system of claim 11 wherein the script associates the viewstate with the one or more forms using a library, and submits the information in the one or more forms using the library.
